(19) United States
(12) Patent Application Publication
(10) Pub. No.: US 2009/0245092 A1
(43) Pub. Date: Oct. 1, 2009

(54) APPARATUS, PROCESSES, AND ARTICLES OF MANUFACTURE FOR FAST FOURIER TRANSFORMATION AND BEACON SEARCHING

(75) Inventors: Hemanth Sampath, San Diego, CA (US); Xin Zhang, San Diego, CA (US); Jeremy H. Lin, San Diego, CA (US); Nistha Sharma, Broomfield, CO (US); Ravi Palanki, San Diego, CA (US); Sunil K. Kandukuri Narayan, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/408,378

(22) Filed: Mar. 20, 2009

Related U.S. Application Data
(60) Provisional application No. 61/040,310, filed on Mar. 28, 2008.
(60) Provisional application No. 61/040,585, filed on Mar. 28, 2008.

(51) Int. Cl. H04J 11/00; G06F 17/14

(52) U.S. Cl. 370/210; 708/404

(57) ABSTRACT

In embodiments, a wireless receiver employs a hardware-based Fast Fourier Transform (FFT) engine controlled by firmware. The FFT engine executes tasks stored in a task list. Each task is associated with a different portion of a signal, for example, one or more Orthogonal Frequency Division Modulated (OFDM) symbols. Each task may include configuration information for the FFT engine for configuring the engine to process the associated portion of the signal, a pointer to the portion to be processed, and another pointer to the memory for storing the output. The task list may be firmware controlled. Division of the FFT into a configurable hardware part driven by firmware to read and execute the tasks in the task list may speed up the FFT process and make it more flexible. A hardware beacon sorter may be coupled to the FFT engine to sort the sub-carriers according to their energies.

### CLAIM OF PRIORITY UNDER 35 U.S.C. §119

The present Application for Patent claims priority to Provisional U.S. Patent Application Ser. No. 61/040,310, entitled “REUSE ENGINE WITH TASK LIST FOR FAST FOURIER TRANSFORM AND METHOD OF USING THE SAME,” filed on Mar. 28, 2008; and to Provisional U.S. Patent Application Ser. No. 61/040,585, entitled “METHOD AND SYSTEM TO DETECT BEACONS/TONES,” filed on Mar. 28, 2008; each of these Provisional Applications is assigned to the assignee hereof and hereby expressly incorporated by reference herein in its entirety.

### BACKGROUND

1. Field

The present invention relates generally to communications. More particularly, in aspects the invention relates to operation of Fast Fourier Transform engines.

2. Background

Modern wireless communication systems are widely deployed to provide various types of communication applications, such as voice and data applications. These systems may be multiple access systems capable of supporting communication with multiple users by sharing the available system resources (e.g., spectrum and transmit power). Examples of multiple access systems include code division multiple access (CDMA) systems, time division multiple access (TDMA) systems, frequency division multiple access (FDMA) systems, time division duplexing (TDD) systems, frequency division duplexing (FDD) systems, 3^{rd} generation partnership project long term evolution (3GPP LTE) systems, and orthogonal frequency division multiple access (OFDMA) systems. There are also point-to-point systems, peer-to-peer systems, and wireless local area networks (wireless LANs).

Generally, a wireless multiple access communication system can simultaneously support communications with multiple wireless terminals. Each terminal communicates with one or more base transceiver stations (BTSs or base stations) via transmissions on forward and reverse links. The forward link or downlink refers to the communication link from a base transceiver station to a terminal, and the reverse link or uplink refers to the communication link from a terminal to a base transceiver station. Each of the forward and reverse communication links may be established via a single-in-single-out, multiple-in-single-out, single-in-multiple-out, or a multiple-in-multiple-out (MIMO) communication technique, depending on the number of transmitting and receiving antennae used for the particular link.

MIMO systems are of particular interest because of their relatively higher data rates, relatively longer coverage range, and relatively more reliable transmission of data. A MIMO system employs multiple (N_{T}) transmit antennae and multiple (N_{R}) receive antennae for data communication. A MIMO channel formed by the N_{T} transmit and N_{R} receive antennae may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g. higher throughput and/or greater reliability) if the additional dimensions created by the multiple transmit and receive antennae are used.

OFDM communication systems often perform at least some processing of the received signals in the frequency domain. The received signals are typically transformed from time domain to the frequency domain using Fourier transforms. Conversely, inverse Fourier transforms can be used to transform frequency domain signals to the signals' time domain counterparts.

Fast Fourier Transform (FFT) is a computational algorithm implementing the Fourier transform. The FFT allows the Fourier transform to be performed in fewer computational operations than used for discrete Fourier transform (DFT). Often, the module responsible for the FFT (the “FFT engine”) in a wireless device is implemented as a sequence of “butterflies.” A “butterfly” in this context is a computational portion of the FFT engine that implements a small (relative to the entire FFT engine) DFT. The term “butterfly” typically appears in description of the Cooley-Tukey FFT algorithm. The Cooley-Turkey algorithm breaks down a DFT of composite size n=(r·m) into r smaller transforms of size m, where r is the so-called “radix” of the FFT transform. The breakdown is performed recursively, and the smaller transforms are combined with size-r butterflies, which themselves are DFTs of size r (performed m times on the outputs of the smaller transforms).

In many applications, the parameters of the FFT engine may have to change over time. This could be because the mobile device needs to support multiple system configurations and multiple standards, each requiring different FFT size, for example. Furthermore, the mobile device receiver timing may need to be adjusted dynamically at the input to the FFT engine based on timing algorithms or ranging commands sent by an Access Point or a base transceiver station. There is thus a need for a flexible FFT architecture.

Many real-time operations may need to be undertaken on the frequency domain FFT output. One example is the detection of the presence of strong sub-carriers that may have beacons or power boosted pilots on each OFDM symbol output. Note that in OFDM communication techniques, some sub-carriers may be power boosted relative to other sub-carriers, and different levels of power boosting may be applied to different boosted sub-carriers. The power boosted sub-carriers may include, for example, pilots and beacons. The receiver may need to detect such power boosted sub-carriers in a relatively short time. For example, fast detection of pilots is typically important to obtain timing in a receiving device and achieve system synchronization.

A need therefore exists in the art for techniques that speed up detection of power boosted sub-carriers in OFDM systems, for example, by attaching a processor that can pick out the strong tones of an OFDM transmission on a symbol-by-symbol basis.

Additional real-time operations may include filtering the FFT output by a frequency domain filter to compensate for various RF impairments and other analog/digital time-domain filtering effects. There is thus a need to attach a frequency domain filter to the FFT engine that can perform real-time filtering of the FFT output.

### SUMMARY

Embodiments disclosed herein may address one or more of the above stated needs by providing apparatus, methods, and articles of manufacture for performing fast Fourier transform in a configurable, task-driven FFT engine, which may also be configured to scale intermediate results between the butterflies, thereby allowing bit-width reduction of the butterflies and buffers. The FFT engine may be coupled to a hardware sorter for picking out the strongest OFDM sub-carriers, and/or to a frequency domain compensating filter.

In an embodiment, a communication method includes a step of receiving a signal to obtain a received signal, and a step of transforming the received signal in a hardware-based Fast Fourier Transform (FFT) engine controlled by firmware to obtain a transformed signal. The step of transforming includes maintaining a task list in a task list memory, the task list comprising a plurality of task entries, each task entry of the plurality of task entries comprising (i) an associated configuration description for the FFT engine during transforming of a portion of the received signal associated with said each task entry, and (ii) first information defining a location of the portion of the received signal associated with said each task entry. The step of transforming also includes reading said each task entry. The step of transforming additionally includes configuring the FFT engine according to the configuration description associated with said each task entry. The step of transforming further includes processing the portion of the received signal associated with said each task entry in the FFT engine configured according to the configuration description associated with said each task entry to obtain a processed portion of signal associated with said each task entry.

In an embodiment, a receiver system includes a receiver configured to receive a signal and output a received signal, and a receive data processor. The receive data processor includes a hardware-based Fast Fourier Transform (FFT) engine controlled by firmware to transform the received signal to obtain a transformed signal. The receive data processor is configured to: (1) maintain a task list in a task list memory, the task list comprising a plurality of task entries, each task entry of the plurality of task entries comprising (i) an associated configuration description for the FFT engine during transforming of a portion of the received signal associated with said each task entry, and (ii) first information defining a location of the portion of the received signal associated with said each task entry; (2) read said each task entry; (3) configure the FFT engine according to the configuration description associated with said each task entry; and (4) process the portion of the received signal associated with said each task entry in the FFT engine configured according to the configuration description associated with said each task entry to obtain a processed portion of signal associated said each task entry.

In an embodiment, a computer program product includes a computer-readable medium with stored instructions for communicating wirelessly. The instructions include code for receiving a signal to obtain a received signal. The instructions also include code for transforming the received signal in a hardware-based Fast Fourier Transform (FFT) engine controlled by firmware to obtain a transformed signal. The code for transforming includes code for maintaining a task list in a task list memory, the task list comprising a plurality of task entries, each task entry of the plurality of task entries comprising (i) an associated configuration description for the FFT engine during transforming of a portion of the received signal associated with said each task entry, and (ii) first information defining location of the portion of the received signal associated with said each task entry. The code for transforming also includes code for reading said each task entry, configuring the FFT engine according to the configuration description associated with said each task entry, and processing the portion of the received signal associated with said each task entry in the FFT engine configured according to the configuration description associated with said each task entry to obtain a processed portion of signal associated said each task entry.

In an embodiment, a receiver system includes a receiver configured to receive a signal and output a received signal, and a means for processing. The means for processing includes a hardware-based means for performing Fast Fourier Transform (FFT) controlled by firmware to transform the received signal to obtain a transformed signal. The means for processing is configured to: (1) maintain a task list in a task list memory, the task list comprising a plurality of task entries, each task entry of the plurality of task entries comprising (i) an associated configuration description for the FFT engine during transforming of a portion of the received signal associated with said each task entry, and (ii) first information defining a location of the portion of the received signal associated with said each task entry; (2) read said each task entry; (3) configure the FFT engine according to the configuration description associated with said each task entry; and (4) process the portion of the received signal associated with said each task entry in the FFT engine configured according to the configuration description associated with said each task entry to obtain a processed portion of signal associated said each task entry.

In an embodiment, a receiver system includes a receiver configured to receive a received signal comprising a plurality of sub-carriers, and a receive data processor. The receive data processor includes a Fast Fourier Transform (FFT) engine configured to transform the received signal to obtain a transformed signal. The receive data processor also includes a hardware sorter configured to sort the sub-carriers in the transformed signal based on energies of individual sub-carriers, thereby obtaining a set of sorted sub-carriers. The receive data processor additionally includes a selector module configured to select boosted sub-carriers from among the set of selected sub-carriers.

In an embodiment, a receiver system includes a receiver configured to receive a signal comprising a plurality of sub-carriers and output a received signal, and a receive data processor. The receive data processor includes a Fast Fourier Transform (FFT) engine configured to transform the received signal to obtain a transformed signal. The receive data processor also includes a hardware means for sorting the sub-carriers in the transformed signal based on energies of individual sub-carriers to obtain a set of sorted sub-carriers. The receive data processor additionally includes a means for selecting boosted sub-carriers from the set of sorted sub-carriers.

In an embodiment, a communication method includes receiving a signal to obtain a received signal comprising a plurality of sub-carriers. The method also includes transforming the received signal in a Fast Fourier Transform (FFT) engine to obtain a transformed signal. The method further includes sorting in a hardware sorter the sub-carriers of the transformed signal based on energies of the individual sub-carriers, thereby obtaining a set of sorted sub-carriers. The method additionally includes selecting boosted sub-carriers from the set of sorted sub-carriers.

In an embodiment, a computer program product includes a computer-readable medium with stored instructions for communicating wirelessly. The instructions include code for receiving a signal to obtain a received signal comprising a plurality of sub-carriers. The instructions also include code for transforming the received signal in a Fast Fourier Transform (FFT) engine to obtain a transformed signal. The instructions additionally include code for sorting in a hardware sorter the sub-carriers of the transformed signal based on energies of the individual sub-carriers, thereby obtaining a set of sorted sub-carriers. The instructions further include code for selecting boosted sub-carriers from the set of sorted sub-carriers.

In an embodiment, a receiver system includes a hardware receive data processor. The hardware receive data processor has a Fast Fourier Transform (FFT) engine configured to transform a received signal to obtain a transformed signal with a plurality of sub-carriers. The receiver system also includes a hardware sorter configured to sort the sub-carriers in the transformed signal based on energies of individual sub-carriers, thereby obtaining a set of sorted sub-carriers. The receiver system additionally includes a hardware selector module configured to select boosted sub-carriers from among the set of sorted sub-carriers. The receiver system further includes a firmware module configured to filter the sub-carriers with a predetermined energy strength threshold, and store sub-carriers meeting the threshold in a FWBeacon array. The FWBeacon array has a TimeLocation portion, a SubcarrierLocation portion, and a BeaconStrength portion.

These and other aspects of the present invention will be better understood with reference to the following description, drawings, and appended claims.

### BRIEF DESCRIPTION OF THE DRAWINGS

FIG. 1 illustrates selected elements of a multiple access wireless communication system which may be configured in accordance with embodiments described in this document;

FIG. 2 illustrates in block diagram manner selected components of a wireless MIMO communication system that may be configured in accordance with embodiments described in this document;

FIG. 3 illustrates selected features of a symbol generated in or received by a terminal;

FIG. 4 illustrates selected components of a receiver of the terminal shown in FIG. 2;

FIG. 5 illustrates selected components of a receive data processor of the terminal of FIG. 2;

FIG. 6A illustrates selected components of a fast Fourier transform engine;

FIG. 6B illustrates selected details of a recursive implementation of the Fourier transform engine of FIG. 6A;

FIG. 7A illustrates selected components of a fast Fourier transform engine with data normalization;

FIG. 7B illustrates selected details of a recursive implementation of the Fourier transform engine of FIG. 7A;

FIG. 8 illustrates selected aspects of an array in which a received digital signal may be divided into cells according to FFT size and sample rate;

FIG. 9A illustrates selected aspects of an example of a received signal containing beacons;

FIG. 9B illustrates selected steps and decision blocks of a process for detecting power boosted sub-carriers;

FIG. 10 is a block diagram illustrating selected aspects of an exemplary apportioning of various tasks among hardware, firmware, and software;

FIG. 11 is a block diagram illustrating selected aspects of another exemplary apportioning of various tasks among hardware, firmware, and software; and

FIG. 12 shows a flowchart illustrating selected steps and decisions of a process for power boosted sub-carrier acquisition.

### DETAILED DESCRIPTION

In this document, the words “embodiment,” “variant,” and similar expressions are used to refer to a particular apparatus, process, or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place may refer to a different apparatus, process, or article of manufacture. The expressions “alternative embodiment,” “alternative variant,” “alternatively,” and similar phrases may be used to indicate one of a number of different possible embodiments or variants. The number of possible embodiments or variants is not necessarily limited to two or any other quantity.

The word “exemplary” may be used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make and use the invention, and not necessarily to limit the scope of legal protection afforded the invention.

“Tone” and “sub-carrier” are generally used interchangeably to indicate individual tones in an OFDM or OFDMA system.

“Gain control device” and “data normalization device” are used interchangeably. Such devices are described in the context of fast Fourier transform engines.

“Firmware” refers to computer code instructions fixed (stored permanently or semi-permanently) in a memory of a device. Generally, firmware is a form of “low-level” code that is specifically tailored for the hardware of the device. Firmware can also be understood as hardware-specific instructions for execution in the hardware device, which can include machine language instructions, configuration settings, and similar information. Firmware operations are typically limited to the hardware that it is tied to and do not typically involve any “higher” level of processing or control. When firmware is not “burnt” permanently into the memory, it is typically still more difficult to update than software, for example, requiring special procedures such as authorized downloading. Firmware, in the conventional sense, is a well understood term. “Hardware” is also a well understood term. “Hardware” refers to physical components of a computer or another electronic system. “Software” generally refers to computer code instructions other than firmware. Conventional approach to designing communication systems is to have the incoming or received signals recognized and converted, whereas the “processing” of the signals is performed by a hardware controller or main processor running software. Conversely, for outgoing signals, typically the hardware controller or the main processor performs the relevant processing.

The techniques described in this document may be used for various wireless communication networks, including CDMA networks, TDMA networks, FDMA networks, OFDM and OFDMA networks, Single-Carrier FDMA (SC-FDMA) networks, and other networks and peer-to-peer systems. The techniques may be used on both forward and reverse links. Further, the techniques are not necessarily limited to wireless or other communication systems, but may be used in any apparatus where signals are processed in a fast Fourier transform engine. The terms “networks” and “systems” are often used interchangeably. A CDMA network may implement a radio technology such as Universal Terrestrial Radio Access (UTRA), cdma2000, and other technologies. UTRA networks include Wideband-CDMA (W-CDMA) and Low Chip Rate (LCR) networks. The cdma2000 designates IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, and other technologies. UTRA, E-UTRA, and GSM are parts of Universal Mobile Telecommunication System (UMTS). Long Term Evolution (LTE) is a release of UMTS that uses E-UTRA. UTRA, E-UTRA, GSM, UMTS and LTE are described in documents from an organization known as the “3rd Generation Partnership Project” (3GPP). The cdma2000 standard is described in documents from an organization known as the “3rd Generation Partnership Project 2” (3GPP2). Certain aspects of the techniques are described in the context of LTE systems, and LTE terminology may be used in the description below, but the techniques may be applicable to other standards and technologies.

Single carrier frequency division multiple access (SC-FDMA) is a communication technique which utilizes single carrier modulation and frequency domain equalization. SC-FDMA systems typically have similar performance and essentially the same overall complexity as OFDMA system. SC-FDMA signals have lower peak-to-average power ratio (PAPR) because of the technique's inherent single carrier structure. The SC-FDMA technique is attractive in many systems, especially in the reverse link communications where the lower PAPR benefits the mobile terminal in terms of transmit power efficiency. The SC-FDMA technique is currently a working assumption for the uplink multiple access scheme in 3GPP Long Term Evolution and Evolved UTRA.

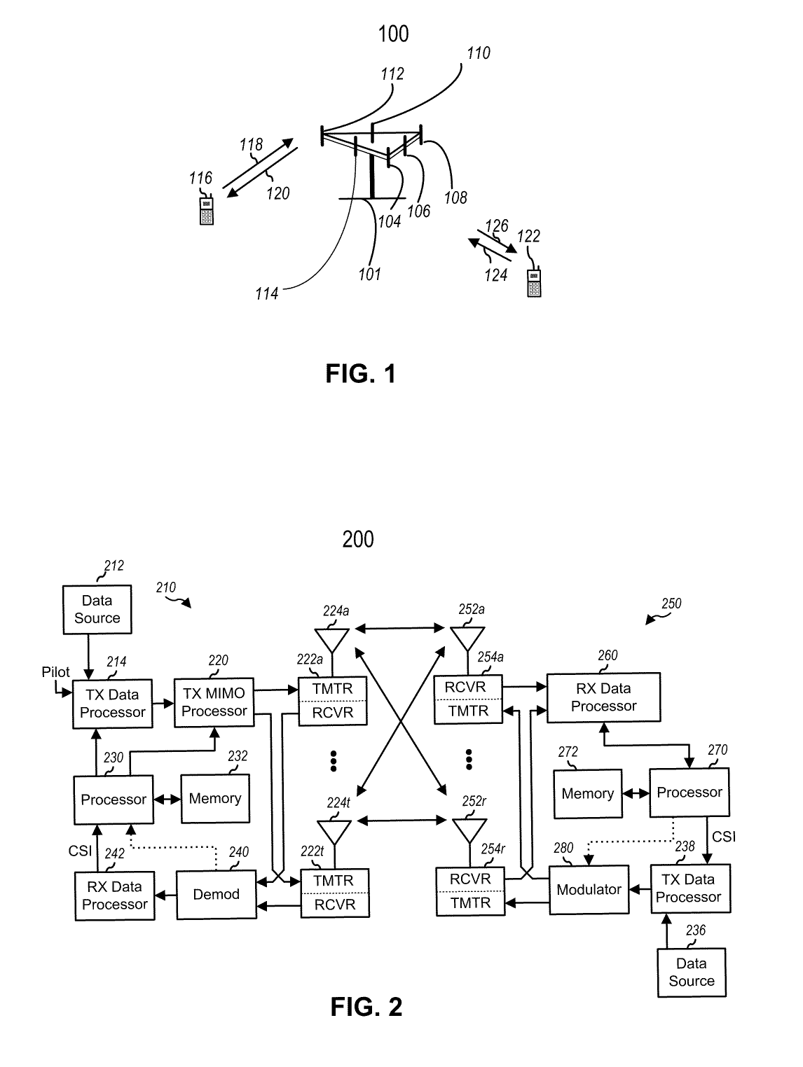

A multiple access wireless communication system 100 according to one embodiment is illustrated in FIG. 1. An access point or a base transceiver station 101 includes multiple antenna groups, one group including antennae 104 and 106, another group including antennae 108 and 110, and an additional group including antennae 112 and 114. Although only two antennae are shown for each antenna group, more or fewer antennae may be included in any of the antenna groups. The BTS 101 may also include a single antenna group, or have only a single antenna. An access terminal (AT) 116 is in communication with the antennae 112 and 114, where antennae 112 and 114 transmit information to the access terminal 116 over a forward link 120, and receive information from the access terminal 116 over a reverse link 118. Another access terminal 122 is in communication with antennae 106 and 108, where the antennae 106 and 108 transmit information to the access terminal 122 over a forward link 126 and receive information from the access terminal 122 over a reverse link 124. In an FDD system, each of the communication links 118, 120, 124 and 126 may use a different frequency for communications between access terminals and a particular antenna or antenna group, as well as different frequencies for forward and reverse links. For example, the forward link 120 may use a different frequency then that used by the reverse link 118, and still another frequency than that used by the forward link 126. The use of different frequencies, however, is not necessarily a requirement of the invention.

Each group of antennae and the area in which it is designed to communicate is often referred to as a sector. As shown in FIG. 1, each of the antenna groups is designed to communicate to access terminals in a different sector of the area covered by the BTS 101.

In communications over the forward links 120 and 126, the transmitting antennae of the BTS 101 use beamforming in order to improve the signal-to-noise ratio of the forward links for the different access terminals 116 and 122. Additionally, beamforming reduces interference for access terminals in neighboring cells, as compared to forward link transmissions through a single antenna to all its access terminals. Beamforming is also not necessarily a requirement of the invention.

An access point or a base transceiver station may be a fixed station used for communicating with the terminals and may also be referred to as a Node B or by some other term. An access terminal may also be called a mobile unit, user equipment (UE), a wireless communication device, terminal, mobile terminal, or some other term.

FIG. 2 shows, in a block diagram form, selected components of an embodiment of a wireless MIMO communication system 200 that includes a transmitter system 210 of a base transceiver station and a receiver system 250 of an access terminal.

At the transmitter system 210, traffic data for a number of data streams is provided by a data source 212 to a transmit (Tx) data processor 214. In an embodiment, each data stream is transmitted over a respective transmit antenna or antenna group. The Tx data processor 214 formats, codes, and interleaves the traffic data for each data stream based on a particular coding scheme selected for that data stream to provide coded data. The coded data for each data stream may be multiplexed with pilot data using OFDM techniques. The pilot data is a known data pattern that is processed in a known manner and may be used at the receiver system to estimate the physical channel response or transfer function. The multiplexed pilot and coded data for each data stream are then modulated (i.e., symbol mapped) based on a particular modulation scheme selected for that data stream, to obtain modulation symbols. The modulation scheme may be selected, for example, from binary phase-shift keying (BPSK), quadrature phase-shift keying (QPSK), M-ary Phase-Shift Keying (M-PSK), and multilevel quadrature amplitude modulation (M-QAM). The data rate, coding, and modulation for each data stream may be determined by instructions performed by a processor 230.

The modulation symbols for all data streams are provided to a Tx MIMO processor 220, which may further process the modulation symbols (e.g., for OFDM). The Tx MIMO processor 220 then provides N_{T} modulation symbol streams to N_{T} transmitters (TMTRs) 222a through 222t. In certain embodiments, the Tx MIMO processor 220 applies beamforming weights to the symbols of the data streams and to the antennae from which the symbols are transmitted.

Each transmitter 222 receives and processes a respective symbol stream to provide one or more analog signals, and further conditions (e.g. amplifies, filters, upconverts) the analog signals to provide a modulated signal suitable for transmission over its corresponding MIMO channel. The N_{T} modulated signals from the transmitters 222a through 222t are transmitted from the N_{T} antennae 224a through 224t, respectively. The antennae 224 may be the same as or different from the antennae 104-114 shown in FIG. 1.

At the receiver system 250, the transmitted modulated signals are received by N_{R} antennae 252a through 252r, and the received signal from each antenna 252 is provided to a respective receiver (RCVR) 254a through 254r. Each of the receivers 254 conditions (e.g., filters, amplifies, downconverts) its respective received signal, digitizes the conditioned signal to provide samples, and further processes the samples to provide a corresponding received symbol stream.

A receive (Rx) data processor 260 receives and processes the N_{R} received symbol streams from the N_{R} receivers 254, based on a particular receiver processing technique, to provide N_{T} detected symbol streams. The Rx data processor 260 then demodulates, deinterleaves, and decodes each detected symbol stream to recover the traffic data of the data stream. The processing by the Rx data processor 260 is complementary to that performed by the Tx MIMO processor 220 and the Tx data processor 214 at the transmitter system 210.

A processor 270 periodically determines which pre-coding matrix to use. The processor 270 formulates a reverse link message comprising a matrix index portion and a rank value portion. The reverse link message may include miscellaneous information regarding the communication link and/or the received data stream.

The reverse link message is then processed by a Tx data processor 238, which also receives traffic data for a number of data streams from a data source 236. The traffic data and the reverse link message are modulated by a modulator 280, conditioned by transmitters 254a through 254r, and transmitted to the transmitter system 210.

At the transmitter system 210, the modulated signals from the receiver system 250 are received by the antennae 224, conditioned by receivers 222, demodulated by a demodulator 240, and processed by an Rx data processor 242 to extract the reverse link messages transmitted by the receiver system 250. The processor 230 determines which pre-coding matrix to use for determining the beamforming weights, and processes the extracted message.

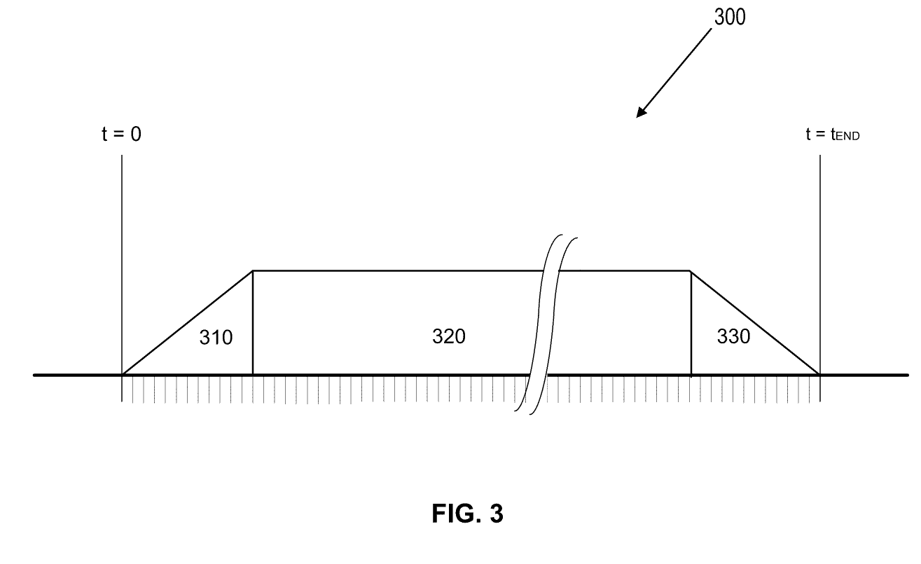

FIG. 3 illustrates selected features of an OFDM symbol 300 of data transmitted according to selected aspects of this disclosure. The symbol 300 begins at a time t=0 and ends at a time t_{END}. The symbol 300 includes a leading ramp portion 310, a data portion 320 (which may include payload or traffic data and certain overhead, such as a cyclic prefix), and a trailing ramp portion 330. The leading and trailing portions are also known as windows and are generally present to smooth transitions from symbol to symbol and to lower the associated spectral spread of the transmitted signal. FIG. 3 is merely an illustration of data according to the present disclosure, and other methods of transmission may be used. For example, the use of OFDM symbols each having a plurality of sub-carriers is not necessarily a requirement of the invention. Note also that transmitted power of different sub-carriers may differ, with some sub-carriers being power boosted relative to other sub-carriers.

Generally, a power boosted sub-carrier is a sub-carrier transmitted with a higher power than at least one other sub-carrier of the same symbol, or more typically, with a higher power than a majority of sub-carriers of the same symbol. A sub-carrier may be power boosted for all or part of a transmission, for example, for the duration of one or more OFDM symbols. Power boosted sub-carriers may include pilots and/or beacons. A pilot or beacon may be used, for example, for training and synchronization. The same sub-carriers may be used as beacons for a complete transmission or for a partial block of OFDM data.

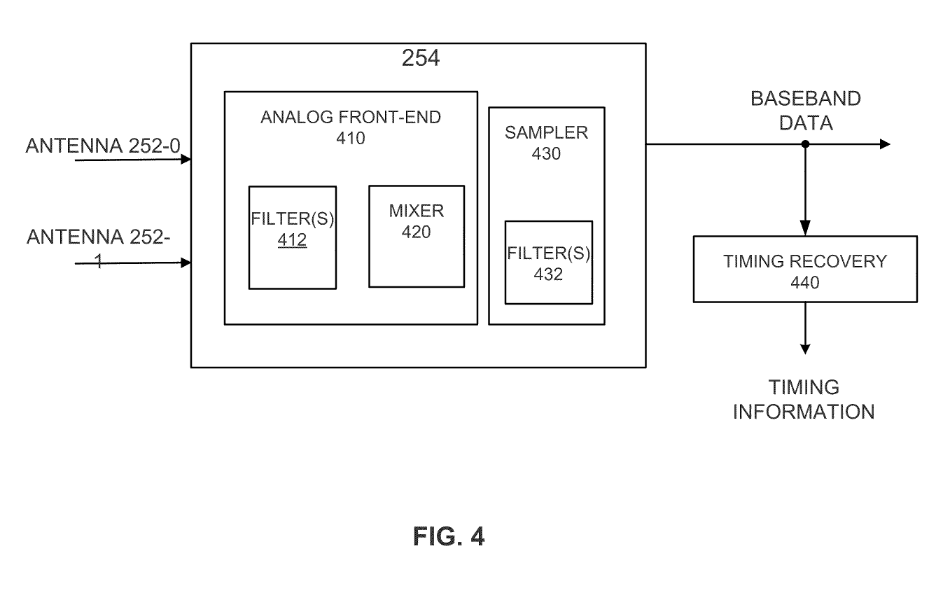

FIG. 4 illustrates selected details of a receiver 254 (which is one of the receivers 254a-254r shown in FIG. 2). The receiver 254 receives signals from its associated antenna or antennae 252. Thus, the receiver 254a receives signals from an antenna (or antennae) 252a, while the receiver 254r receives signals from an antenna (or antennae) 252r. The illustration of FIG. 4 and the associated description may apply to any and each of the receivers 254, for example, to the receiver 254a and to the receiver 254r. While some details of the architecture of the receiver 254 are not shown, it should be appreciated that many known and possibly later-developed architectures may be used. In various exemplary embodiments, the modules 410-440 can take the form of separate electronic components coupled together via a series of separate busses. In other embodiments, one or more of the various modules 410-440 can take form of processors or separate servers coupled together via one or more networks. Additionally, it should be appreciated that each of the modules 410-440 advantageously can be realized using multiple computing devices employed in a cooperative fashion. It also should be appreciated that some of the modules 410-440 can take the form of software/firmware structures and routines residing in a memory to be executed or worked upon by a controller, or software/firmware routines or structures residing in separate memories in separate servers/computers being operated upon by different controllers.

In operation, as signals are received by antenna 252-0 and/or antenna 252-1 (and/or any other antenna 252 associated with the receiver 254 shown in FIG. 4), the analog front-end 410 is configured to accept the received signals, condition the signals, and provide the conditioned signals to a mixer 420. Front-end signal conditioning may include filtering the signals through one or more filters 412 in the front-end 410.

The mixer 420 is configured to downconvert the conditioned signals from their received frequency spectrum to a lower baseband spectrum. The converted baseband signals are then provided to a sampler 430, which is configured to convert the analog baseband signals into digital data. One or more filters 432 may be used to filter the baseband signal further, either before or after sampling. Thus, the filter(s) 432 may be analog and/or digital, depending on whether they operate before or after sampling conversion.

While ideal filters may introduce no phase delay, have a flat profile across all received frequencies, and may exhibit a perfect cutoff at any frequency, known realizable filters deviate from such “ideal” filter performance. The filters 412 and 432 may thus introduce distortion to the received signals. For example, one or both of the filters or filter sets 412 and 432 may introduce to the received signal frequency-dependent amplitude and/or phase distortions, such as pass-band amplitude and/or phase ripple.

A timing recovery device 440 is configured to apply various algorithms to the received data to derive timing information from the signals. There may be inadvertent time offsets τd present, which timing recovery device 440 may eventually recognize and report.

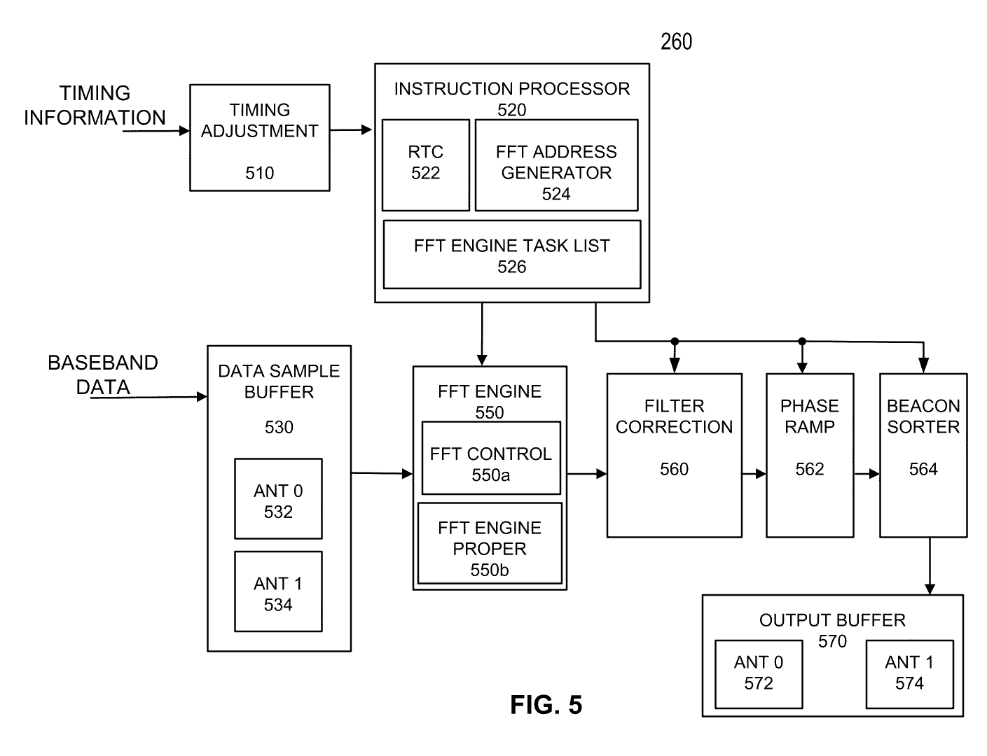

FIG. 5 illustrates selected details of the Rx data processor 260 (from FIG. 2), which here is configured to receive both timing information and baseband data from the receivers 254. While some details of the architecture of the exemplary Rx data processor 260 are not shown, it should be appreciated that any known or possibly later-developed architectures may be used. In exemplary embodiments, the various modules 510-574 can take the form of separate electronic components coupled together via a series of separate busses. In other embodiments, one or more of the various modules 510-574 can take form of processors or separate servers coupled together via one or more networks. Additionally, it should be appreciated that each of the modules 510-574 advantageously can be realized using multiple computing devices employed in a cooperative fashion. It also should be appreciated that some of the modules 510-574 can take the form of software/firmware structures and routines residing in a memory to be executed or worked upon by a controller, or software/firmware routines or structures residing in separate memories in separate servers/computers being operated upon by different controllers.

The exemplary data processor 260 includes a timing adjustment block 510; an instruction processor block 520, which may be a sequential instruction machine such as a DSP or another processor controller; an input data sample buffer 530; a Fast Fourier Transform (FFT) engine 550 that includes an FFT control device 550a and an FFT engine proper 550b; a filter correction device 560; a phase ramp block 562; a beacon sorter 564; and an output buffer 570. The instruction processor block 520 includes a real-time clock or counter (RTC) 522, an FFT address generator 524, and an FFT Engine Task List memory 526. The data sample buffer 530 includes separate blocks 532 and 534 for data associated with different antennae. The output buffer 570 similarly includes separate blocks 572 and 574 for output data associated with the different antennae.

In operation, the timing adjustment block 510 is configured to receive the timing information, and to provide an output time offset τd to the instruction processor block 520. The time offset τd can further be passed on to the phase ramp block 562.

The input data sample buffer 530 is configured to receive sample baseband data via one or more antennae 252 of the respective receiver 254, possibly through the front end 410, and to provide buffered data samples to the FFT engine 550.

The FFT address generator 524 of the processor block 520 is configured to generate addresses for use by the FFT engine 550. The control block 550a of the FFT engine 550 receives the addresses generated by the FFT address generator 524 and the commands and variables stored in the FFT Engine Task List 526, and based on this received information configures the FFT engine proper 550b, so that the FFT engine 550 converts the buffered data samples from which communication channels may be resolved.

In the hardware/software/firmware architecture, the FFT Engine Task List 526 may store various instructions, various variables, and/or operational data for use by the FFT control block 550a. As non-limiting examples, the FFT Engine Task List 526 may contain separate entries (tasks), with each of the tasks containing variable(s) representing a sample start address indicating where the data for a transformation is stored; an output address indicating where the data output by the FFT engine (the transformed data) is to be dumped or stored; instructions for reading or supplying the sample start address; variable(s) representing the number of data symbols to skip before or between executions of the Fourier transform; instructions for skipping a number of data symbols before or between executions; variable(s) representing FFT Length; variable(s) representing the number of FFT stages or butterflies to be executed; instructions for executing multiple FFT stages; variable(s) representing scaling or gain control for each FFT stage to be executed (as will be discussed in more detail below); instructions for executing scaling at or following each FFT stage/butterfly; variable(s) representing a start time for each FFT operation to be executed; instructions for starting an FFT operation; variable(s) indicating a bit for instant start; and/or instructions for performing an instant start. These are merely examples, and other instructions, variables, and/or data items may be stored in the FFT Engine Task List 526.

The contents of the FFT Engine Task List 526 can be held in a memory, and can be updated and modified with new or different instructions, variables, and/or data as, needed.

The instructions, variables, and/or operational data held in the FFT Engine Task List 526 can be requested by the FFT control block 550a and stored in registers of the block 550a, or can be presented to the FFT control block 550a by the instruction processor 520 without a specific request from the block 550a.

After the FFT engine 550 has converted the received and buffered time domain data samples into a block of frequency-domain data, a total of k rows of OFDM data are provided to the filter correction device 560. Each orthogonal frequency component will have a resolved values for its frequency fₖ and time t, as represented by the following equation:

I+jQ=A exp(−j 2π fₖ t),

where A designates amplitude, I designates in-phase part of the frequency component, and Q designates the quadrature part of the frequency component.

Note that in practical operation, the FFT data may require amplitude and/or phase corrections.

We now proceed to describe the mechanisms for the FFT engine to accommodate a large dynamic range of the received time-domain signals.

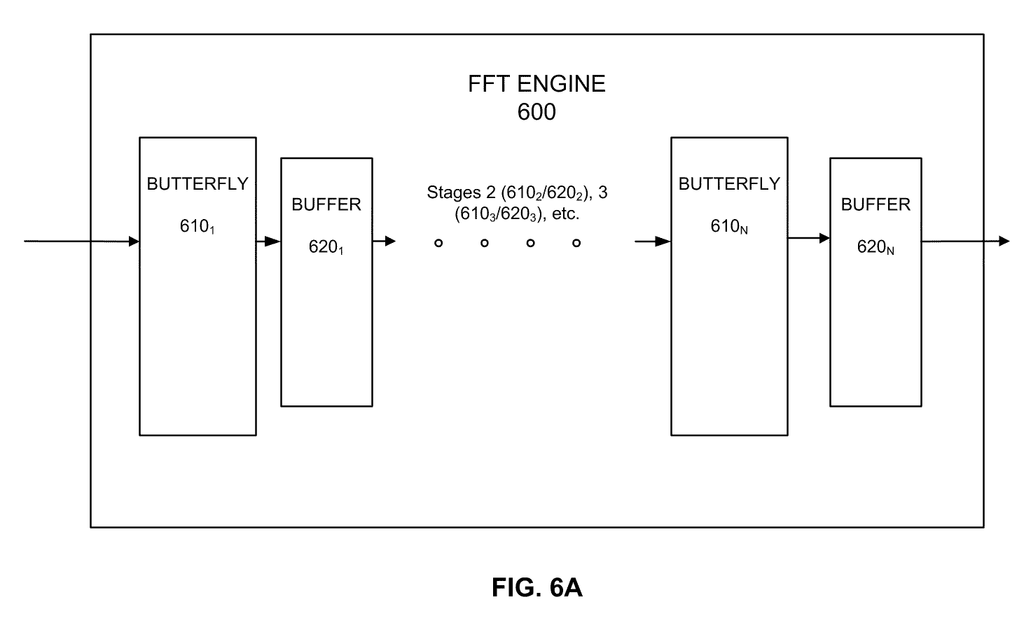

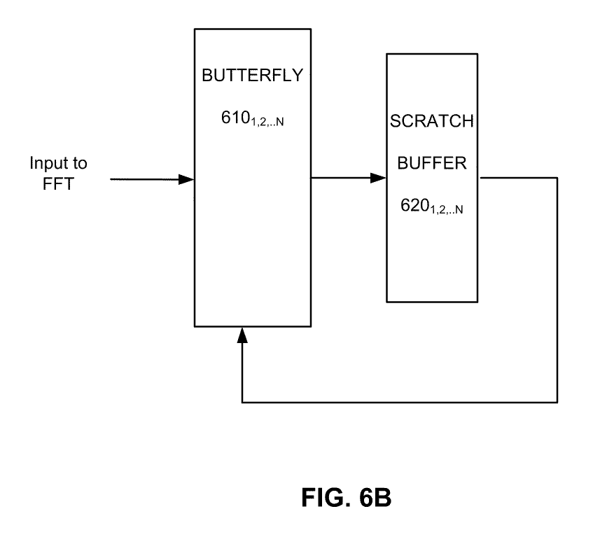

FIG. 6A illustrates selected elements of an FFT engine 600 (which may be the same as the FFT engine 550). The FFT engine 600 includes a plurality of N internal FFT stages or butterflies 610ₙ. (Recall discussion of butterflies above.) Each butterfly 610 is followed by a buffer 620 configured to receive and store the output of the nearest preceding butterfly 610, and to provide the stored data as input to the nearest following butterfly 610. Although FIG. 6A shows only two butterflies 610 and two associated buffers 620, the FFT engine 600 may have a greater or a smaller number of the butterflies 610, with 3-4 being a typical number of butterflies in many designs. For example, the FFT engine 600 may include four, eight, or sixteen butterflies and an equal number of their associated buffers.

Successive butterflies 610 are employed in successive stages of the FFT process. Thus, butterfly 610₁ is used in the first stage of the FFT engine 600, and its output is stored in the buffer 620₁. The contents of the buffer 620₁ are then taken up by the butterfly 610₂ in the second stage of the FFT engine 600, and its output is stored in the buffer 620₂. The contents of the buffer 620₂ are in turn provided to the input of the butterfly 610₃ in the third stage of the FFT engine 600, and the output of the butterfly 610₃ is stored in the buffer 620₃.

The symbols output by the FFT engine 600 across the different FFT sub-carriers can have a large dynamic range, because of factors that include frequency domain channel variations, differences in the transmitted power among different sub-carriers or tones, and perhaps other factors. Regarding the differences in the transmitted power, beacons in some embodiments may be 30 dB stronger than other sub-carriers, and forward link control channel tones may be 0 to 15 dB stronger than other sub-carriers. If the FFT engine 600 does not normalize signals after each butterfly stage, its output can become saturated, leading to distortion of symbols on the saturated sub-carriers, and consequent poor demodulation performance on such sub-carriers. Further, if the FFT engine 600 does not normalize the signals after each bufferfly stage, the storage size of the buffers 620 and a buffer (or buffers in case of double buffering) configured to receive the output of the FFT engine 600 may be large relative to analogous buffers in systems configured to process signals having a smaller dynamic range.

It should be noted that in the FFT engine 600 multiple butterfly-buffer stages may be replaced with one such stage configured to operate successively. This is illustrated in FIG. 6B, which shows a single stage with one butterfly 610_{1, 2 . . . N} that performs functions of two or more (including all) of the butterflies 610 shown in FIG. 6A, and one buffer 620_{1, 2 . . . N} that performs functions of two or more (including all) of the buffers 620 shown in FIG. 6A. Here, the stage is configured successively as the first stage (butterfly 610₁ and buffer 620₁), then as the second stage (butterfly 610₁ and buffer 620₁), and so on, with output of a preceding stage being fed into input of the following stage. We may refer to such configuration as a recursive FFT engine configuration.

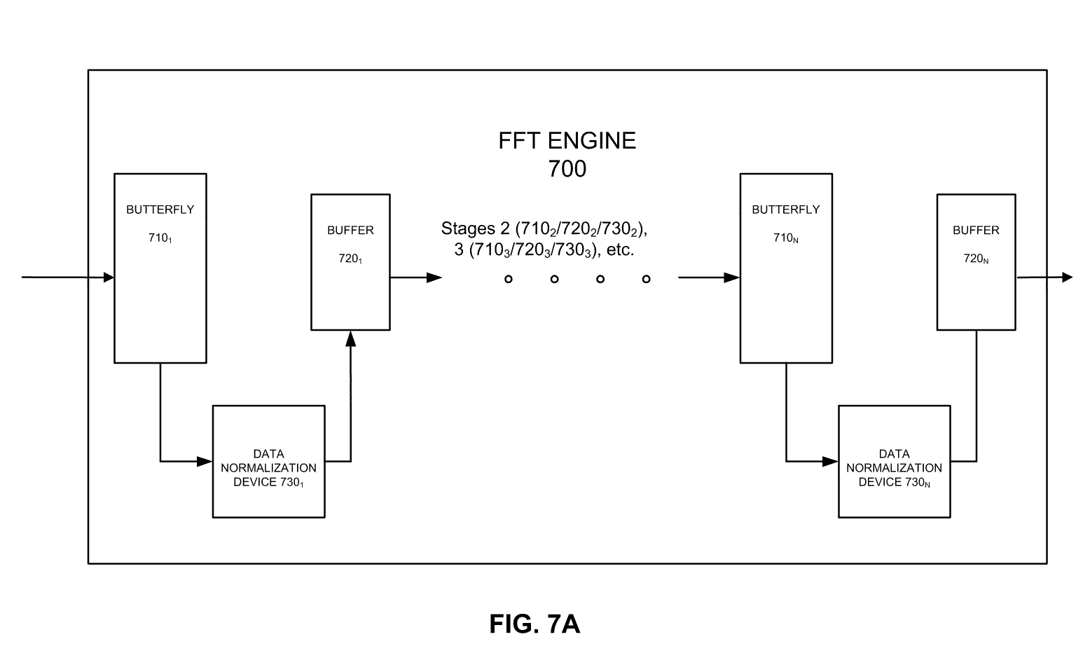

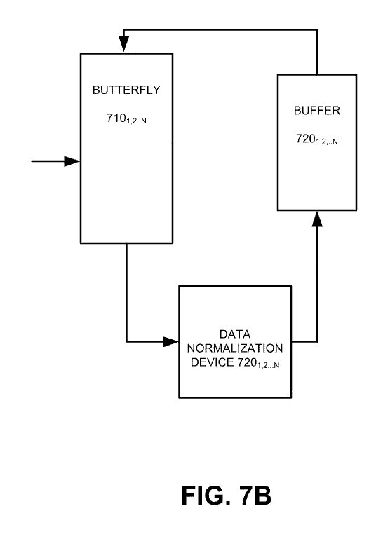

FIG. 7A illustrates another FFT engine implementation, which uses data normalization devices or gain control devices at the outputs of each of the butterflies. This implementation is also described in a commonly assigned patent application entitled MULTIPLE STAGE FOURIER TRANSFORM APPARATUS, PROCESSES, AND ARTICLES OF MANUFACTURE, docket number 081017, which claims priority from U.S. Provisional Patent Application Ser. No. 61/040,324.

The FFT engine 700 shown in the FIG. 7A (which may be the same as the FFT engine 550) has a plurality of N internal FFT stages or butterflies 710ₙ. Each butterfly 710 is followed by its associated data normalization or gain control device 730 and a buffer 720. Thus, the stages of the engine 700 are configured in series to process a signal received at the input to the first stage 710₁/720₁/730₁ successively through the stages and then output from the output of the last stage 710_{N}/720_{N}/730_{N}. Note that the gain control device 730ₙ is interposed between its associated (nearest preceding) butterfly 710ₙ and the buffer 720ₙ associated with that butterfly. The gain control device 730ₙ normalizes (scales to a predetermined amplitude scale/range) the output of its associated butterfly 710ₙ, for example by multiplying or dividing the output in the digital domain, and provides the resulting output to the nearest following buffer 720ₙ, as shown. The buffer 720ₙ is configured to receive and store the output data of the nearest preceding gain control device 730ₙ, and to provide the stored data to the nearest following butterfly 710ₙ₊₁. Although FIG. 7A shows only two butterflies 710, two buffers 720, and two gain control devices 730, the FFT engine 700 may have a greater or a smaller number of the butterflies, buffers, and data normalization devices. Some embodiments contain two, three, four, eight, or sixteen butterflies, and equal numbers of their associated buffers and data normalization devices. Moreover, the number of stages may be configurable by the information stored in the FFT Engine Task List 526.

Successive butterflies 710 are employed in successive stages of the FFT process. Thus, the butterfly 710₁ is used in the first stage of the FFT engine 700, and its output is sent to the gain control device 730₁ and then (after normalization/scaling) stored in the buffer 720₁. The contents of the buffer 720₁ are taken up by the butterfly 710₂ in the second stage of the FFT engine 700, and its output is provided to the gain control device 730₂ and stored in the buffer 720₂, again after appropriate scaling. The contents of the buffer 720₂ are in turn provided to the input of the butterfly 710₃ in the third stage of the FFT engine 700, and the output of the butterfly 710₃ is sent to the gain control device 730₃ and stored in the buffer 720₃. And so it continues through the last stage N with its butterfly 710_{N}, gain control device 730_{N}, and buffer 720_{N}.

In operation, the first butterfly stage is executed, for example in the butterfly 710₁. The output data from the butterfly 710₁ is normalized by the device 730₁, e.g. so that all signals within the current data block fall between predetermined maximum and minimum amplitudes of the signal. Next, the normalized data is stored in the buffer 720₁. The buffered data from the buffer 720₁ is sent to the next butterfly 710₂, for the next FFT stage, and the steps are then repeated (with changes in the subscripts) for the following butterflies.

It should be noted that in the FFT engine 700 multiple butterfly-buffer-normalization device stages may be replaced with one such stage configured to operate successively. This is illustrated in FIG. 7B, which shows a single stage with one butterfly 710_{1, 2 . . . N} that performs functions of two or more (including all) of the butterflies 710 shown in FIG. 7A, one buffer 720_{1, 2 . . . N} that performs functions of two or more (including all) of the buffers 720 shown in FIG. 7A, and one gain control device 730_{1, 2 . . . N} that performs functions of two or more (including all) of the gain control devices 730 shown in FIG. 7A. Here, the stage is configured successively as the first stage (butterfly 710₁, buffer 720₁, and gain control device 730₁), then as the second stage (butterfly 710₂, buffer 720₂, and gain control device 730₂), and so on, with output of a preceding stage being fed into input of the following stage. As in the case of the FFT engine 600 (of FIG. 6B), we may refer to such configuration as a recursive FFT engine configuration.

Recall that the filter 412 in the front-end 410 and the filter 432 in the sampler 430 may introduce some amount of phase and/or amplitude distortion, which may be frequency dependent and cause degradation of performance in OFDM and other communication systems. Let A_{fk} represent the composite amplitude distortion of the filters 412 and 432 for a given sub-carrier fₖ, and let p_{cfk} represent the composite phase distortion of filters 412 and 432. As a person skilled in the art would understand after perusal of this document, A_{fk} and p_{cfk} may each vary with the sub-carrier, and more generally with signal frequency. In the frequency domain, the composite amplitude and phase distortion of the two filters may then be represented by Ac, which may be written as follows:

Acfk=A_{fk} exp(−j p_{cfk})).

In embodiments of a receiver 254, the effect of the amplitude and/or phase distortions is reduced or eliminate through a post-FFT frequency domain compensation. Towards that end, the frequency response of filters 412 and 432 is stored in a memory, which may be internal to the filter correction block 560, or external to the block 560. In various embodiments, the filter frequency response data may be computed or measured during manufacture of the receiver 254 and stored in the memory, may be uploaded to the memory as firmware, and/or may be computed by the filter correction block 560 upon processing of internally generated or otherwise known signals.

As the FFT engine 550 provides sample data in the frequency domain, the filter correction device 560 may multiply each frequency sub-carrier of the post-FFT signal by a frequency-dependent parameter Acfk⁻¹, which is the reciprocal of the stored filter response for the corresponding frequency, to obtain a corrected signal, approximating processing by ideal filters substituted for the filters 412 and 432.

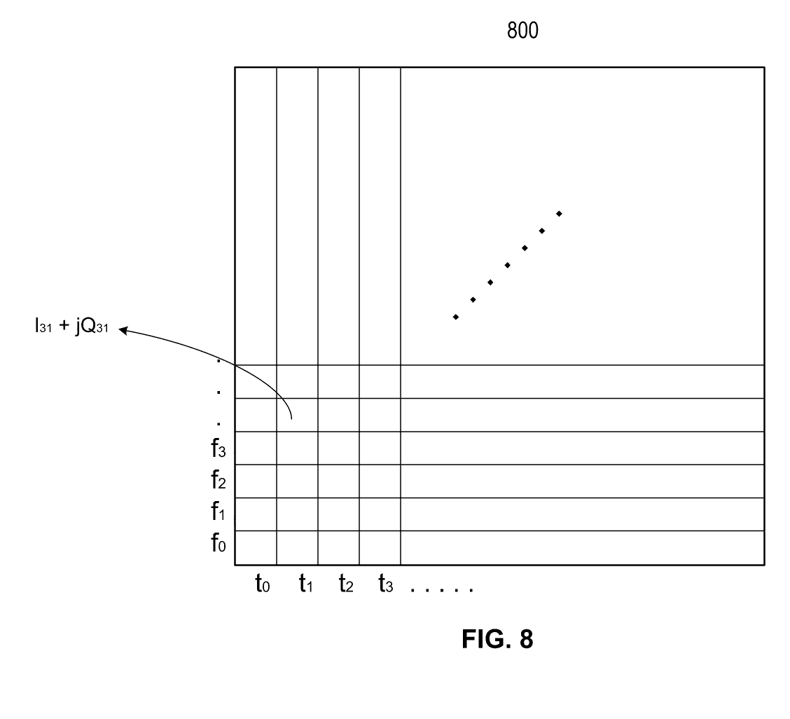

FIG. 8 illustrates selected aspects of an array 800 in which a received digital signal may be divided into cells according to the FFT size and the sample rate, i.e., the number of OFDM sub-carriers and the number of samples in a period of time. Each cell of the array may be processed by the filter correction block 560, and may effectively be multiplied by Acfk¹ to compensate for the known amplitude and phase distortions of filters 412 and 432 corresponding to the specific sub-carrier(s).

The corrected data output by the filter correction device 560 is provided to the phase ramp block 562 to compensate or adjust for timing offsets, which in the frequency domain appear as a rotation of an FFT output value. The phase ramp block 562 may be configured to receive timing information, such as a time offset, via the instruction processor 520 for a given block of OFDM data. The timing offset information (expressed as τd) may be determined for each block of OFDM information, and a respective phase correction coefficient may be calculated for each frequency or sub-carrier fₖ in an OFDM block according to the following formula:

D_{fk}=exp(−j 2π fk(τd)).

The above architecture addresses time offset correction in the frequency domain through compensation at the phase ramp block 562. When sample data arrives from the data sample buffer 530, the FFT engine 550 transforms the sample data into the frequency domain. Then, the phase ramp block 562 multiplies each frequency band of the post-FFT signal by D_{fk}¹, the reciprocal of the above phase correction coefficient Dₖ, effectively to shift the signal in the time domain back to where it should have been had no delay time offset occurred. The values D_{fk}⁻¹ may be recomputed for each frequency fk upon receipt of the next block of OFDM data.

As shown in FIG. 5, the beacon sorter 564 receives the output of the phase ramp block 562, which output has been corrected for time offset and the distortions introduced by the filters 412 and 432. The beacon sorter 564 is configured to identify the power boosted sub-carriers such as beacons from among the k sub-carriers of the transmission, as is described below.

Each sub-carrier of frequency fₖ has a complex amplitude at time t, which may be expressed as I_{cfk}+jQ_{cfk}. In some embodiments, the beacon sorter 564 is configured to estimate the total energy E_{cfk} of each individual sub-carrier of frequency fₖ for a time t by computing the sum of the squared I and Q terms: E_{cfk}=(I_{cfk})²+(Q_{cfk})².

The value E_{cfk} may then be summed across a given frequency fₖ, e.g. across a “row” in FIG. 8, to determine the total energy for a sub-carrier for a period of time corresponding to the row. The period may correspond, for example, to one or more OFDM symbols. In this way, the beacon sorter 564 can determine the energy of each sub-carrier, and then identify a subset of one or more sub-carriers as beacons. In some embodiments, a predetermined number of beacons with the highest energies are identified as the power boosted sub-carriers. For example, four or eight sub-carriers with the highest energies may be presumed to be beacons or other power boosted sub-carriers.

Alternatively or additionally, a subset of the highest-energy sub-carriers may be identified by the beacon sorter 564 as power boosted sub-carriers based on a set of other stored rules. As an example, the beacon sorter 564 may be configured to determine the energy difference between adjacent sub-carriers, and then identify those sub-carriers with the largest energy differences from their neighbors as power boosted sub-carriers. This approach tends to compensate somewhat for the frequency-dependent nature of fading, because the adjacent sub-carriers may be affected by fading to a similar extent as the power boosted sub-carrier. Other stored rules may be used as well.

Where two or more antennae are used, the value E_{cfk} may be summed across the antennae for each sub-carrier.

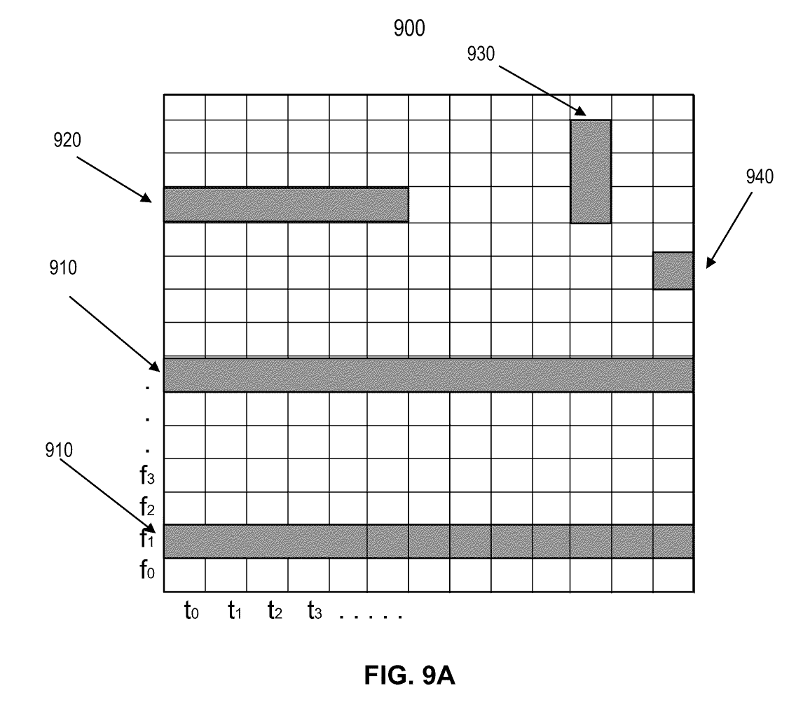

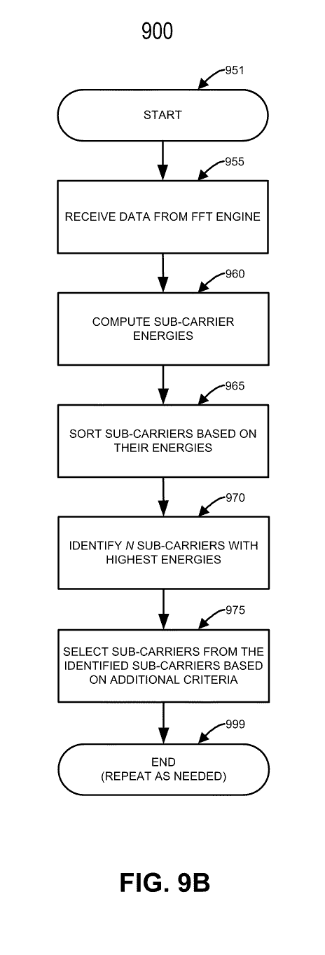

FIG. 9A illustrates selected aspects of an example 900 of received signal containing beacons according to one embodiment. Note that one or more frequencies fₖ (each shown as a row) may be reserved entirely for power boosted sub-carriers, as in sub-carriers 910, or may only be used as power boosted sub-carriers for a limited time, as is the case with sub-carriers 920. Some beacons may be sent on multiple frequencies, but only for a fixed time t, as in the case of sub-carriers 930. Single frequencies and times may also be used as beacons, as in the case of sub-carriers 940. The beacon sorter 564 may be configured to resolve any of these power boosted sub-carriers or combinations of power boosted sub-carriers.

FIG. 9B illustrates selected steps and decision blocks of a process 950 for detecting power boosted sub-carriers. The process 950 may be implemented in the sorter 564, following the output of the FFT engine 550.

The process 950 begins at a flow point 951 and ends at a flow point 999. It should be noted that the process would typically be repeated.

At step 955, the output of the FFT engine is received. The output may be received directly from the FFT engine, or it may have been corrected for time offset and filter distortions, as has been discussed, and/or may have been otherwise processed.

At step 960, energy of each of the sub-carriers is computed, for example, by summing the squared I and Q terms (E_{cfk}=(I_{cfk})²+(Q_{cfk})²).

At step 965, the sub-carriers are sorted in order of their respective energies. Sorting may be performed in increasing or decreasing order, for example.

At step 970, a predetermined number N of sub-carriers with the highest energies is identified. The predetermined number may be programmable or configurable, and may fall inclusively between 2 and 10. Values outside the range are also possible. This determination may be simply taking the first N sub-carriers where the sorting was performed in the order of decreasing energies, or taking the last N sub-carriers where the sorting was performed in the order of increasing energies.

At step 975, a subset of the N identified sub-carriers is selected based on additional criterion or criteria. Note that in some embodiments, all of the N identified sub-carriers are automatically selected, corresponding to the absence of the additional selection criteria. In other embodiments, additional testing is performed, for example, comparison of each of the identified sub-carrier to its immediate neighbors (nearest frequencies), and only those of the identified sub-carriers that exceed their immediate neighbors by a predetermined power difference are selected. The predetermined power difference may correspond (exactly or substantially) to 2, 3, 5, or 10 dB, for example. This process may result in all, none, or some of the identified sub-carriers to be finally selected.

The process 950 then terminates at the flow point 999.

Returning to FIG. 5, the beacon sorter 564 can report a sub-channel index, a sub-channel strength, a beacon time window, or any combination thereof. Thus, the output buffer 570 receives one or more identifications of beacon frequencies and/or times from the beacon sorter 564, along with the time-offset-corrected and filter-corrected sample output.

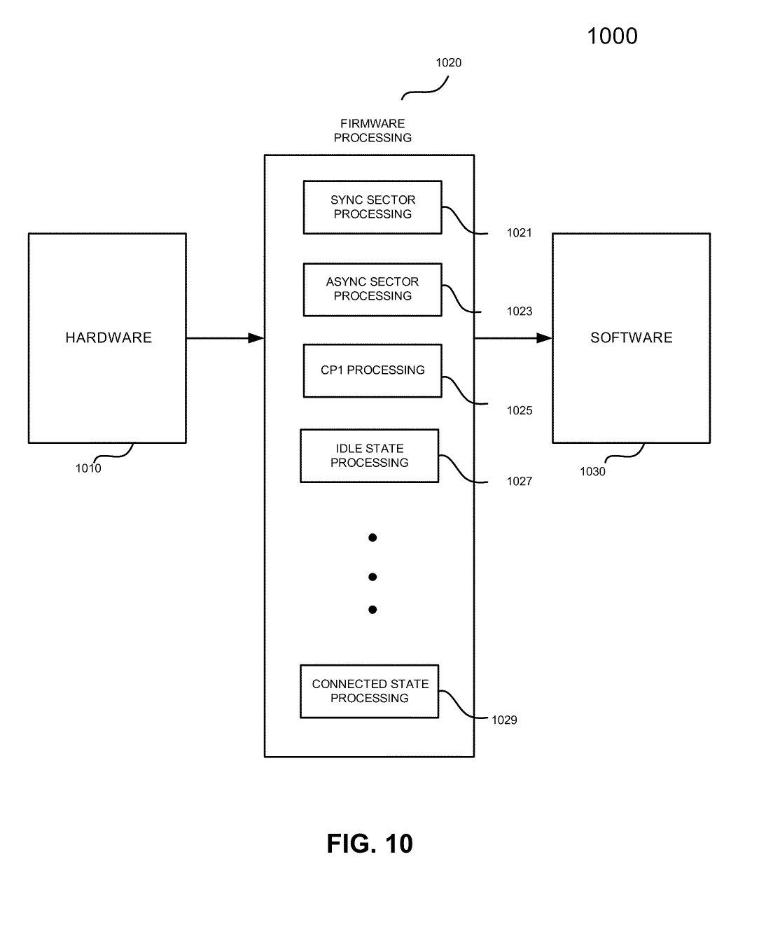

FIG. 10 is a block diagram illustrating an exemplary apportioning 1000 of various tasks between hardware module 1010, firmware module 1020, and software module 1030 in a wireless communication apparatus, such as the receiver system 250 of FIG. 2. The hardware module 1010 may receive a signal and perform processing operations on the signal, such as a FFT or IFFT, as non-limiting examples. The hardware processed signal is then operated on by the firmware processing module 1020, where one or more layers of mid-to-high level processing is performed on the signal. The firmware module 1020 may include, as illustrative examples, sync sector processing block 1021, async sector processing block 1023, idle state processing block 1027, connected state processing block 1029, and other blocks. After processing by the firmware module 1020, the signal is forwarded to the software module 1030 for further processing and control. It should be understood that various portions of the firmware processing blocks may be further separated into individual blocks.

As is illustrated in FIG. 10, several forms of signal and information processing may be performed at the firmware processing level, rather than at the hardware processing level. In this way, the hardware processor may be alleviated of many tasks that it would otherwise have to perform. Accordingly, a greater degree of configurability of systems, lowered complexity, lowered hardware requirements, and improved response and performance can be achieved by partitioning algorithms across the hardware module 1010, firmware module 1020, and software module 1030.

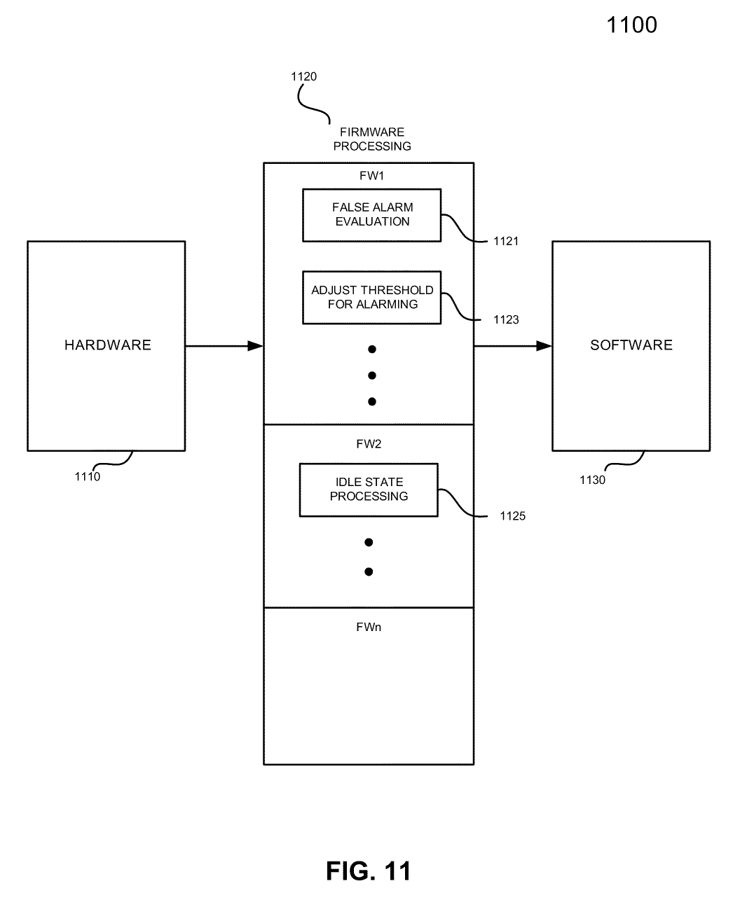

FIG. 11 is a block diagram illustrating another exemplary apportioning 1100 of various tasks among hardware module 1110, firmware module 1120, and software module 1130 in a wireless communication apparatus, such as the receiver system 250 of FIG. 2. Specifically, the firmware module 1120 includes false alarm controls (1121 and 1123) being handled by a firmware module FW1. Other firmware modules, such as idle state processing 1125, may be handled by a firmware module FW2 of the firmware module 1120. The firmware module 1120 may also include other modules FWn for performing additional functions. Apportioning of tasks to firmware instead of hardware may improve the efficiencies in performance and configurability of the overall system 250.

In the context of the FFT engine 550 (FIG. 5) and its controls, the division between hardware and firmware may be implemented as follows. In the hardware (e.g., the FFT engine proper 550b), there are a number of parameters that can be configured, including, for example, a sample start address for a transformation; variable(s) representing the number of data symbols to skip before or between executions of the Fourier transform; variable(s) representing FFT Length; variable(s) representing the number of FFT stages or butterflies to be executed; variable(s) representing scaling or gain control for each FFT stage to be executed; variable(s) representing a start time for each FFT operation to be executed; a bit for instant start; and/or other operational/configuration data.

In operation, the FFT control block 550a may be implemented with firmware-stored instructions to read a task from the FFT Engine Task List 526 and configure the FFT engine proper 550b in accordance with the instructions. The hardware FFT engine proper 550b executes an FFT transformation of data and dumps the transformed data as defined by the task. The FFT engine 550 may then move on to the next task, as needed. The individual entries in the FFT Engine Task List 526 may also be written under firmware control. In this way, the hardware and firmware are decoupled, allowing great flexibility in configuring the FFT engine proper 550b and the high speed of essentially hardware-based FFT processing.

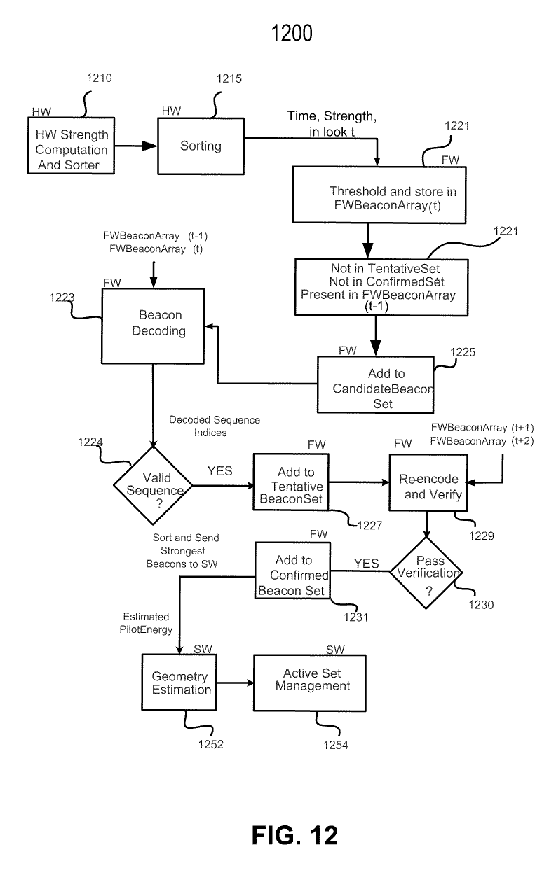

FIG. 12 shows a flowchart illustrating selected steps of a process 1200 for exemplary power boosted sub-carrier acquisition, using an exemplary architecture with apportionment among hardware, firmware, and software, in accordance with certain aspects of embodiments described in this document. The process may be performed in a wireless receiver, such as an access terminal receiver system 250.

In step 1210, strengths of the sub-carriers of an OFDM symbol for a particular time are computed by the FFT engine hardware, configured as has been described above, including firmware control of the configuration.

In step 1215, the sub-carriers are sorted in accordance with their strength. This step is also performed by the FFT engine hardware, using the sorter 564.

In step 1221, the sorted sub-carriers from the step 1215 are filtered with a programmable or otherwise predetermine energy strength threshold and the sub-carriers meeting the threshold are stored in the form of TimeLocation, SubcarrierLocation, and BeaconStrength, in an array FWBeaconArray(t). This step in done in firmware to allow for more flexibility in filtering and programming of the threshold that allows adjustment of false alarm sensitivities. The following steps are also performed in Firmware.

Firmware maintains two arrays corresponding to strength-frequency (SF) pair (t) and (t−1), corresponding to the current (t) and previous (t−1) time period or OFDM symbol, respectively. The TimeLocation variable of a sub-carrier indicates whether a particular sub-carrier strength corresponds to t or (t−1); the SubcarrierLocation variable indicates the particular tone in the OFDM symbol; and the BeaconStrength variable of the sub-carrier indicates the strength of the sub-carrier during the corresponding time.

In step 1222, sub-carriers to be added to the CandidateBeaconsSet are determined, and the addition of the sub-carriers is performed in step 1225. The CandidateBeaconSet is a set from which the power boosted sub-carriers are selected.

Typically, the CandidateBeaconSet contains the top N (e.g., N≦8) entries from FWBeaconArray(t) that are present in FWBeaconArray(t−1) and are not present in TentativeBeaconSet and ConfirmedBeaconSet of the sub-carriers. The TentativeBeaconSet stores the sub-carriers that have been tentatively verified to be Beacons, via a single-shot beacon decoding algorithm. The ConfirmedBeaconSet stores the sub-carriers that have fully been verified to be Beacons, via multiple beacon decoding algorithms, over multiple time instances. The CandidateBeaconSet, TentativeBeaconSet, and ConfirmedBeaconSet are maintained by firmware of the system.

Various operation can then be performed by software on the confirmed sub-carriers, such as geometry estimation in step 1252 and active set management in step 1254. Other operations on the confirmed sub-carriers may include synchronization (particularly for pilots) and control information receipt.

The power boosted sub-carriers are then used for communication purposes in accordance with their purposes. For example, pilots may be used for timing recovery and synchronization, facilitating decoding of information (payload) carrying beacons. The payload carrying beacons may be decoded and the information they carry may be displayed, sounded, or otherwise rendered to the user of the wireless receiver. If the beacons carry information, for example, overhead, the information may be decoded and also used for the intended purposes, such as establishing communication channels. The information in the beacons may be decoded and also used to facilitate communication of the user, for example, in rendering data carried by other sub-carriers. Generally, the confirmed power boosted sub-carriers may be used to facilitate receiving or sending through a wireless channel of payload data, such as audio data, image data, video data, and other useful data transmitted wirelessly. The received data may be rendered at the access terminal or another wireless apparatus where the process is performed.

Although steps and decision blocks of various methods may have been described serially in this disclosure, some of these steps and decisions may be performed by separate elements in conjunction or in parallel, asynchronously or synchronously, in a pipelined manner, or otherwise. There is no particular requirement that the steps and decisions be performed in the same order in which this description lists them, except where explicitly so indicated, otherwise made clear from the context, or inherently required. It should be noted, however, that in selected variants the steps and decisions are performed in the particular sequences described above and/or shown in the accompanying Figures. Furthermore, not every illustrated step and decision may be used in every system, while some steps and decisions that have not been specifically illustrated may be desirable in some systems.

It should be noted that, in aspects, the inventive concepts disclosed may be used on forward links, reverse links, peer-to-peer links, and in other non-multiple access contexts. It should also be noted that the communication techniques that are described in this document may be used for unidirectional traffic transmissions, as well as for bidirectional traffic transmissions.

Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Those of skill in the art would further appreciate that the various illustrative logical blocks, modules, circuits, and algorithm steps described in connection with the embodiments and variants disclosed herein may be implemented as electronic hardware, computer software, or combinations of both. To show clearly this interchangeability of hardware and software, various illustrative components, blocks, modules, circuits, and steps may have been described above generally in terms of their functionality. Whether such functionality is implemented as hardware, software, or combination of hardware and software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments and variants disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g. a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof If implemented in software, the functions may be stored on or transmitted over as one or more instructions or code on a computer-readable medium. Computer-readable media include both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, flash memory, or any other medium that can be used to carry or store desired program code in the form of instructions or data structures and that can be accessed by a computer. Also, any connection may be properly termed a computer-readable connection medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of connection medium. Disk and disc, as used herein, include compact disc (CD), laser disc, optical disc, digital versatile disc (DVD), floppy disk, and blu-ray disc where “disks” usually reproduce data magnetically, while “discs” reproduce data optically with lasers and LEDs. Combinations of the above should also be included within the scope of computer-readable media.

The previous description of the disclosed embodiments and variants is provided to enable any person skilled in the art to make or use the present invention. Various modifications to these embodiments will be readily apparent to those skilled in the art, and the generic principles defined herein may be applied to other embodiments. Thus, the present invention is not intended to be limited to the embodiments and variants shown herein, but is to be accorded the widest scope consistent with the principles and novel features disclosed herein.

What is claimed is:

1. A communication method, comprising steps of:
transforming the received signal in a hardware-based Fast Fourier Transform (FFT) engine controlled by firmware to obtain a transformed signal;
wherein the step of transforming comprises:
maintaining a task list in a task list memory, the task list comprising a plurality of task entries, each task entry of the plurality of task entries comprising (i) an associated configuration description for the FFT engine during transforming of a portion of the received signal associated with said each task entry, and (ii) first information defining a location of the portion of the received signal associated with said each task entry;
reading said each task entry;
configuring the FFT engine according to the configuration description associated with said each task entry; and
processing the portion of the received signal associated with said each task entry in the FFT engine configured according to the configuration description associated with said each task entry to obtain a processed portion of signal associated with said each task entry.

2. The communication method of claim 1, wherein the step of transforming further comprises reading the portion of the received signal associated with said each task entry from the location in accordance with the first information; and
the method further comprises at least one of (a) rendering data contained in the received signal, (b) transmitting information based on data contained in the received signal, and (c) receiving additional data in accordance with the data contained in the received signal.

3. The communication method of claim 1, wherein said each task entry further comprises (iii) second information defining a location for storing the processed portion of signal associated said each task entry, and the method further comprises receiving the received signal.

4. The communication method of claim 3, wherein:
the configuration description for the FFT engine during transforming of the portion of the received signal associated with said each task entry comprises FFT length.

5. The communication method of claim 3, wherein:
the configuration description for the FFT engine during transforming of the portion of the received signal associated with said each task entry comprises a number of FFT stages to be executed.

6. The communication method of claim 3, wherein:
the configuration description for the FFT engine during transforming of the portion of the received signal associated with said each task entry comprises one or more variables representing gain control for one or more stages of the FFT engine.

7. The communication method of claim 3, wherein:
the FFT engine comprises a plurality of stages, each stage comprises a butterfly, a buffer, and a gain control device configured to scale output of the butterfly engine of said each stage; and
the configuration description for the FFT engine during transforming of the portion of the received signal associated with said each task entry comprises a plurality of variables representing gain control for one or more stages of the FFT engine.

8. The communication method of claim 3, wherein:
the FFT engine comprises a hardware stage in a recursive configuration implementing a plurality of stages, each stage of the plurality of stages comprises a butterfly, a buffer, and a gain control device configured to scale output of the butterfly engine of said each stage; and
the configuration description for the FFT engine during transforming of the portion of the received signal associated with said each task entry comprises a plurality of variables representing gain control for one or more stages of the FFT engine.

9. The communication method of claim 3, wherein the transformed signal comprises a plurality of sub-carriers, the method further comprising:
sorting the sub-carriers in the processed portion based on energies of the individual sub-carriers, thereby obtaining a set of sorted sub-carriers; and
step for selecting boosted sub-carriers from the set of sorted sub-carriers.

10. The communication method of claim 3, wherein the transformed signal comprises a plurality of sub-carriers, the method further comprising:
sorting the sub-carriers in the processed portion based on energies of the individual sub-carriers, thereby obtaining a set of sorted sub-carriers; and
selecting a predetermined number of sub-carriers with highest energies from the set of sorted sub-carriers.

11. A receiver system, comprising:
a receiver configured to receive a signal and output a received signal; and
a receive data processor, the receive data processor comprising a hardware-based Fast Fourier Transform (FFT) engine controlled by firmware to transform the received signal to obtain a transformed signal, wherein the receive data processor is configured to:
maintain a task list in a task list memory, the task list comprising a plurality of task entries, each task entry of the plurality of task entries comprising (i) an associated configuration description for the FFT engine during transforming of a portion of the received signal associated with said each task entry, and (ii) first information defining a location of the portion of the received signal associated with said each task entry;
read said each task entry;
configure the FFT engine according to the configuration description associated with said each task entry; and
process the portion of the received signal associated with said each task entry in the FFT engine configured according to the configuration description associated with said each task entry to obtain a processed portion of signal associated said each task entry.

12. The receiver system of claim 11, wherein the step of transforming further comprises reading the portion of the received signal associated with said each task entry from the location in accordance with the first information; and
the receive data processor is further configured to perform at least one of (a) rendering data contained in the received signal, and (b) perform at least one communication step based on data contained in the received signal.

13. The receiver system of claim 11, wherein:
said each task entry further comprises (iii) second information defining a location for storing the processed portion of signal associated said each task entry.

14. The receiver system of claim 13, wherein:
the configuration description for the FFT engine during transforming of the portion of the received signal associated with said each task entry comprises FFT length.

15. The receiver system of claim 13, wherein:
the FFT engine comprises a plurality of FFT stages; and
the configuration description for the FFT engine during transforming of the portion of the received signal associated with said each task entry comprises a number of the FFT stages to be executed.

16. The receiver system of claim 13, wherein:
the FFT engine comprises a plurality of FFT stages; and
the configuration description for the FFT engine during transforming of the portion of the received signal associated with said each task entry comprises one or more variables representing gain control for one or more stages of the FFT engine.

17. The receiver system of claim 13, wherein:
the FFT engine comprises a plurality of stages, each stage comprises a butterfly, a buffer, and a gain control device configured to scale output of the butterfly engine of said each stage; and
the configuration description for the FFT engine during transforming of the portion of the received signal associated with said each task entry comprises a plurality of variables representing gain control for the plurality of stages of the FFT engine.

18. The receiver system of claim 13, wherein:
the FFT engine comprises a hardware stage in a recursive configuration implementing a plurality of stages, each stage of the plurality of stages comprises a butterfly, a buffer, and a gain control device configured to scale output of the butterfly engine of said each stage; and
the configuration description for the FFT engine during transforming of the portion of the received signal associated with said each task entry comprises a plurality of variables representing gain control for one or more stages of the plurality of stages of the FFT engine.

19. The receiver system of claim 13, wherein the received signal comprises a plurality of sub-carriers, the receiver system further comprising:
a hardware sorter configured to sort the sub-carriers in the processed portion based on energies of individual sub-carriers, thereby obtaining a set of sorted sub-carriers; and
means for selecting boosted sub-carriers from the set of sorted sub-carriers.

20. The receiver system of claim 13, wherein the received signal comprises a plurality of sub-carriers, the method further comprising:
a sorter configured to sort the sub-carriers in the processed portion based on energies of individual sub-carriers, thereby obtaining a set of sorted sub-carriers; and
selecting a predetermined number of sub-carriers with highest energies from the set of sorted sub-carriers.

21. A computer program product, comprising:
computer-readable medium comprising:
code for causing a computer to communicate wirelessly, comprising:
receiving a signal to obtain a received signal; and
transforming the received signal in a hardware-based Fast Fourier Transform (FFT) engine controlled by firmware to obtain a transformed signal;
wherein the step of transforming comprises:
maintaining a task list in a task list memory, the task list comprising a plurality of task entries, each task entry of the plurality of task entries comprising (i) an associated configuration description for the FFT engine during transforming of a portion of the received signal associated with said each task entry, and (ii) first information defining location of the portion of the received signal associated with said each task entry;
reading said each task entry;
configuring the FFT engine according to the configuration description associated with said each task entry; and
processing the portion of the received signal associated with said each task entry in the FFT engine configured according to the configuration description associated with said each task entry to obtain a processed portion of signal associated said each task entry.

22. A receiver system, comprising:
a receiver configured to receive a signal and output a received signal; and
a means for processing, the means for processing comprising a hardware-based means for performing Fast Fourier Transform (FFT) controlled by firmware to transform the received signal to obtain a transformed signal, the means for processing being configured to:
maintain a task list in a task list memory, the task list comprising a plurality of task entries, each task entry of the plurality of task entries comprising (i) an associated configuration description for the FFT engine during transforming of a portion of the received signal associated with said each task entry, and (ii) first information defining a location of the portion of the received signal associated with said each task entry,
read said each task entry,
configure the FFT engine according to the configuration description associated with said each task entry, and
process the portion of the received signal associated with said each task entry in the FFT engine configured according to the configuration description associated with said each task entry to obtain a processed portion of signal associated said each task entry.

23. A receiver system, comprising:
a receiver configured to receive a received signal comprising a plurality of sub-carriers; and
a receive data processor, the receive data processor comprising a Fast Fourier Transform (FFT) engine configured to transform the received signal to obtain a transformed signal;
a hardware sorter configured to sort the sub-carriers in the transformed signal based on energies of individual sub-carriers, thereby obtaining a set of sorted sub-carriers; and
a selector module configured to select boosted sub-carriers from among the set of selected sub-carriers.

24. The receiver system of claim 23, wherein the selector is configured to select a predetermined number of sub-carriers with highest energies from the set of sorted sub-carriers.

25. The receiver system of claim 23, wherein the selector module is configured to select a configurable number of sub-carriers with highest energies from the set of sorted sub-carriers.

26. The receiver system of claim 23, wherein the selector module is configured to select a number of boosted sub-carriers from the set of sorted sub-carriers based on energies of individual sub-carriers and comparisons of each sub-carrier with at least one neighbor sub-carrier of said each sub-carrier.

27. The receiver system of claim 23, wherein the selector module is configured to select a number of boosted sub-carriers from the set of sorted sub-carriers based on at least one group of parameters selected from a set consisting of (i) energies of individual sub-carriers, and (ii) comparisons of each sub-carrier with at least one neighbor sub-carrier of said each sub-carrier.

28. The receiver system of claim 27, wherein the selector module is a hardware selector module configurable by firmware.

29. A receiver system, comprising:
a receiver configured to receive a signal comprising a plurality of sub-carriers and output a received signal; and
a receive data processor, the receive data processor comprising a Fast Fourier Transform (FFT) engine configured to transform the received signal to obtain a transformed signal;
a hardware means for sorting the sub-carriers in the transformed signal based on energies of individual sub-carriers to obtain a set of sorted sub-carriers; and
a means for selecting boosted sub-carriers from the set of sorted sub-carriers.

30. A communication method, comprising steps of:
receiving a signal to obtain a received signal comprising a plurality of sub-carriers; and
transforming the received signal in a Fast Fourier Transform (FFT) engine to obtain a transformed signal;
sorting in a hardware sorter the sub-carriers of the transformed signal based on energies of the individual sub-carriers, thereby obtaining a set of sorted sub-carriers; and
selecting boosted sub-carriers from the set of sorted sub-carriers.

31. The communication method of claim 30, wherein the step of selecting comprises choosing a predetermined number of sub-carriers with highest energies from the set of sorted sub-carriers.

32. The communication method of claim 30, wherein the step of selecting comprises choosing a configurable number of sub-carriers with highest energies from the set of sorted sub-carriers.

33. The communication method of claim 30, wherein the step of selecting comprises choosing a number of boosted sub-carriers from the set of sorted sub-carriers based on energies of individual sub-carriers and comparisons of each sub-carrier with at least one neighbor sub-carrier of said each sub-carrier.

34. The communication method of claim 30, wherein the step of selecting comprises choosing a number of boosted sub-carriers from the set of sorted sub-carriers based on at least one group of parameters selected from a set consisting of (i) energies of individual sub-carriers, and (ii) comparisons of each sub-carrier with at least one neighbor sub-carrier of said each sub-carrier.

35. The communication method of claim 34, wherein the step of selecting is performed in a hardware selector configurable by firmware.

36. A computer program product, comprising:
computer-readable medium comprising:
code for causing a computer to communicate wirelessly, comprising:
receiving a signal to obtain a received signal comprising a plurality of sub-carriers;
transforming the received signal in a Fast Fourier Transform (FFT) engine to obtain a transformed signal;
sorting in a hardware sorter the sub-carriers of the transformed signal based on energies of the individual sub-carriers, thereby obtaining a set of sorted sub-carriers; and
selecting boosted sub-carriers from the set of sorted sub-carriers.

37. A receiver system, comprising:
a hardware receive data processor, the hardware receive data processor comprising a Fast Fourier Transform (FFT) engine configured to transform a received signal to obtain a transformed signal, the transformed signal comprising a plurality of sub-carriers;
a hardware sorter configured to sort the sub-carriers in the transformed signal based on energies of individual sub-carriers, thereby obtaining a set of sorted sub-carriers;
a hardware selector module configured to select boosted sub-carriers from among the set of sorted sub-carriers; and
a first firmware module configured to filter the sub-carriers with a predetermined energy strength threshold, and store sub-carriers meeting the threshold in a FWBeacon array, the FWBeacon array comprising a TimeLocation portion, a SubcarrierLocation portion, and a BeaconStrength portion.

38. The receiver system of claim 37, further comprising a second firmware module configured to classify the sub-carriers in the FWBeacon array into a CandidateBeacon set, a Tentativebeacon set, and a ConfirmedBeacon set, wherein the CandidateBeacon set contains a plurality of N sub-carriers with highest energies from the FWBeacon array that are not present in the TentativeBeacon set and ConfirmedBeaconSet.

39. The receiver system of claim 38, wherein the TentativeBeacon set contains the sub-carriers that have been tentatively verified to be Beacons by a single-shot beacon decoding algorithm.

40. The receiver system of claim 38, wherein the ConfirmedBeacon set stores sub-carriers that have fully been verified to be Beacons by multiple beacon decoding algorithms, over multiple time instances.
